(19) United States
(12) Patent Application Publication
(10) Pub. No.: US 2014/0168079 A1
(43) Pub. Date: Jun. 19, 2014

(54) CURSOR CONTROL SYSTEM

(71) Applicant: HSIEN- CHANG HUANG, New Taipei City (TW)

(72) Inventor: HSIEN- CHANG HUANG, New Taipei City (TW)

(21) Appl. No.: 13/714,470

(22) Filed: Dec. 14, 2012

(51) Int. Cl. G06F 3/01

(52) U.S. Cl. CPC G06F 3/017
USPC 345/158

(57) ABSTRACT

Disclosed is a cursor control system for controlling a cursor position of a display screen, and the cursor control system includes a sensing module, a speed tuning module, a signal processing module and a transmission module, and the sensing module includes a direction sensing unit and an acceleration sensing unit, such that an instant posture of a user's hand can be detected, and an intuitive inertial behavior can be used to achieve the effect of controlling a cursor, and the speed tuning module can increase or decrease the moving speed of the display screen cursor to improve the convenience for users to control the cursor.

### FIELD OF THE INVENTION

The present invention relates to a cursor control system, in particular to the cursor control system that allows a user to control a cursor position of a display screen by controlling the user's inertial motion, and increase or decrease the moving speed of a cursor, so as to improve the convenience of the cursor control.

### BACKGROUND OF THE INVENTION

As computer becomes increasingly popular, companies, schools and government agencies start using the computer for presentations in different occasions such as conference, teaching, demonstration, training and announcement. In addition, the use of computers has the advantages of producing slides that can be made and edited easily to support multimedia presentations to make the presentations more vivid and lively, so that the conventional projector used for presentations has been gradually replaced by a presentation system comprised of the computer and the projector.

When a speaker makes a presentation by a presenter at a podium, the speaker sometimes needs to control a screen cursor to click an unopened file. If the presenter has the function of controlling the screen cursor, the speaker no longer needs to walk to a position near the computer to control the presenter. As disclosed in R.O.C. Pat. No. 200737116, entitled “System for controlling mouse cursor of computer by laser spot and R.O.C. Pat. No. 200809584, entitled “Mouse integrated with laser cursor” disclose the systems of controlling a screen cursor by a laser spot by using a video camera to capture a laser spot in an image of a display screen, and a digital image processing technology to detect the position of the laser spot in the captured image, so as to timely control the movement of a screen cursor.

In addition to the aforementioned methods, an accelerometer and a gyroscope (G/Gyro Sensor) is used for detecting the position of a presenter in air, such that when a speaker holds and moves the presenter in an upward, downward, leftward or rightward direction, the screen cursor also moves in an upward, downward, leftward or rightward direction accordingly to achieve the effect of controlling the screen cursor of the presenter.

However, if it is necessary to control and move the screen cursor to a desired icon, the user will press a left button or a right button, so that the user's palm may shake involuntarily and may fail to press the desired icon, particularly if the selected icon is relatively small.

In addition, multimedia games have been developed for years, and the industry of semiconductors advances in recent years to further drives the growth and advancement of the electronic industry, and the operating and processing capabilities of related electronic devices are improved significantly. Regardless of sound, image or animation of the multimedia games have breakthroughs to allow game players to submerge and combine into the fantasy of the audio and video world and enjoy the fun of the multimedia games while playing the games.

In most of the multimedia games, an input interface such as a keyboard, a mouse or a joystick is required for communications between players and the game. Similar to the problems encountered by the presentation remote controller, if the object or icon shown on the screen is relatively small, the user may be unable to press the object or icon due to the handshake occurred when the user is pressing the button. When the mouse or joystick controls the movement of a cursor, a small displacement can control the cursor to move a relatively long distance, and a drag can move the cursor to a fixed position. However, a small tick of the user's fingers may cause a relatively large movement of the cursor, so that the user has difficulties to align with the small icon.

### SUMMARY OF THE INVENTION

In view of the aforementioned problems, it is a primary objective of the present invention to provide a cursor control system, particularly the cursor control system that allows a user to control a cursor position of a display screen by controlling the user's inertial motion, and increase or decrease the moving speed of a cursor, so as to improve the convenience of the cursor control.

To achieve the foregoing objective, the present invention provides a cursor control system for controlling a cursor position of a display screen. The cursor control system comprises a sensing module, a speed tuning module, a signal processing module and a transmission module, wherein the sensing module includes a direction sensing unit and an acceleration sensing unit, such that an instant posture of a user's hand can be detected, and an intuitive inertial behavior can be used for achieve the effect of controlling a cursor. In addition, the speed tuning module can be used for increasing or decreasing the moving speed of the display screen cursor to improve the convenience for the user to control the cursor.

### BRIEF DESCRIPTION OF THE DRAWINGS

FIG. 1 is a schematic block diagram of a cursor control system of the present invention;

FIG. 2 is a schematic view of a cursor control system of the present invention; and

FIG. 3 is a schematic view of using a cursor control system of the present invention.

### DESCRIPTION OF THE PREFERRED EMBODIMENTS

The technical characteristics of the present invention will become apparent with the detailed description of the preferred embodiments accompanied with the illustration of related drawings as follows.

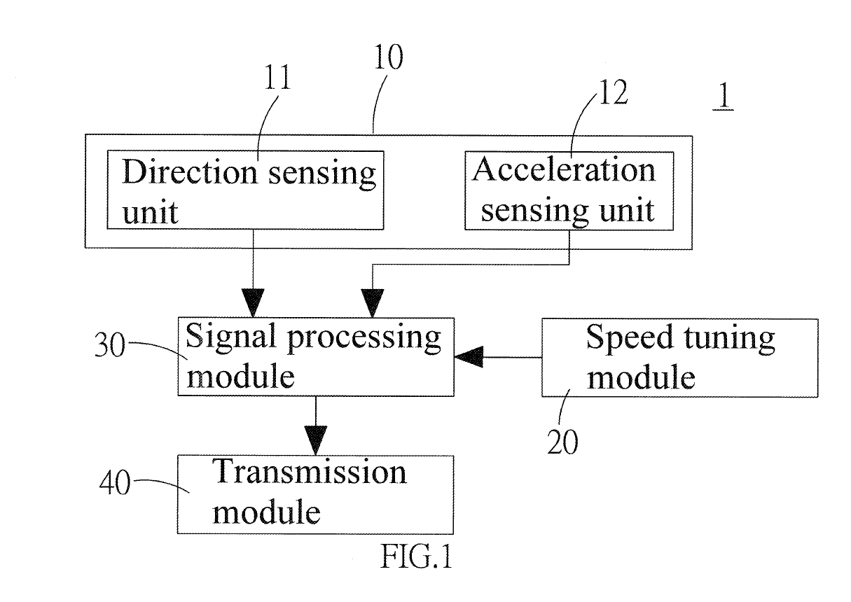

With reference to FIG. 1 for a schematic block diagram of a cursor control system of the present invention, the cursor control system 1 comprises a sensing module 10, a speed tuning module 20, a signal processing module 30 and a transmission module 40.

The sensing module 10 includes a direction sensing unit 11 and an acceleration sensing unit 12, wherein the direction sensing unit 11 can be a gyroscope, a G sensor, a magnetic sensor or an infrared sensor for detecting a user's hand movement to generate an angular speed sensing signal, and the acceleration sensing unit 12 can be a single axis accelerometer or a multi-axis accelerometer, for detecting a user's hand movement to generate an acceleration sensing signal.

The speed tuning module 20 has an acceleration mode and a non-acceleration mode and is capable of generating a corresponding speed adjusting signal.

The signal processing module 30 is coupled to the sensing module 10 and the speed tuning module 20 for receiving the angular speed sensing signal, the acceleration sensing signal and the speed adjusting signal to further tune the acceleration sensing signal by the speed adjusting signal, and convert the angular speed sensing signal and the tuned acceleration sensing signal into a cursor position signal.

The transmission module 40 is coupled to the signal processing module 30 for retrieving the cursor position signal of the signal processing module and capable of outputting the cursor position signal, wherein the transmission module can be in a cable or wireless transmission mode and the wireless transmission mode can be in a Bluetooth or infrared transmission mode.

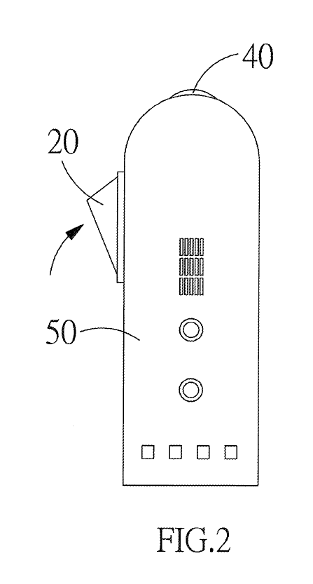

In the preferred embodiment as shown in FIG. 2, the cursor control system 1 is integrated in a remote control body 50, and the speed tuning module 20 is a pressure sensor installed (or built) in the press-button structure, so that the knob structure can be used for switching to the acceleration mode or the non-acceleration mode and controlling an increase or a decrease of the speed. Of course, the speed tuning module can also be a knob structure or a joystick structure.

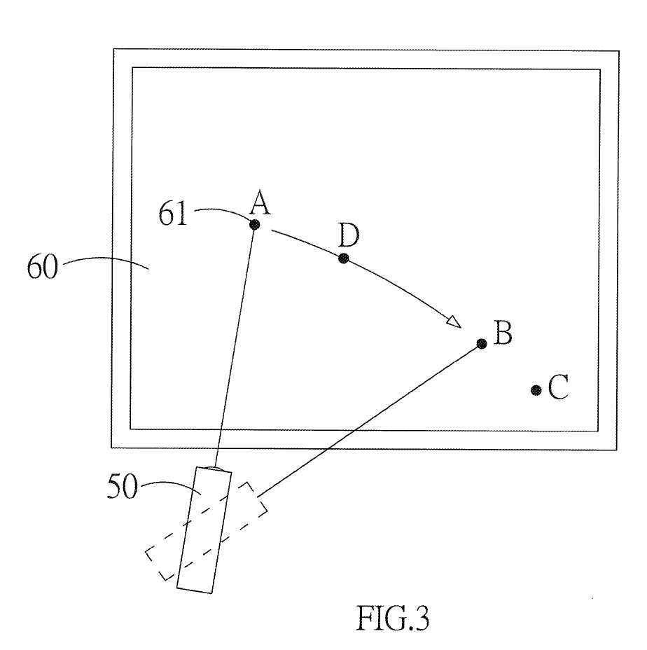

With reference to FIG. 3 for the use of the cursor control system of the present invention, the user can hold the remote control body 50 by a hand to control a specific position of a cursor 61 on a display screen 60. When the user performs an inertial motion such as a wrist movement, the remote control body 50 is moved. Now, the angular speed sensing signal and acceleration sensing signal are detected by the direction sensing unit 11 and the acceleration sensing unit 12 of the sensing module respectively, and the sensing signal is processed and converted into a cursor position signal by the signal processing module 30, and then the cursor position signal is outputted by the transmission module 40, so as to point at the cursor 61 displayed on the display screen 60 for a control, and the cursor 61 is moved from the position of Point A to the position of Point B on the display screen 60.

When the user uses the speed tuning module 20 to switch to an acceleration mode, the corresponding speed adjusting signal is transmitted to the signal processing module 30, and the speed adjusting signal tunes the acceleration sensing signal and convert the tuned signal to an accelerated cursor position signal, so as to point at the cursor 61 displayed on the display screen 60 for a control and move the cursor 61 from the position of Point A to the position of Point B on the display screen 60, and the cursor control system can be used for moving the cursor to a long distance on the display screen.

If the user uses the speed tuning module 20 to switch to the non-acceleration mode such as a constant speed mode, the processing module 30 maintains the same cursor position signal to point at the cursor 61 displayed on the display screen 60 and move the cursor 61 from the position of Point A to the position of Point B on the display screen 60. If the non-acceleration mode is a deceleration mode, the corresponding speed adjusting signal is transmitted to the signal processing module 30, and the speed adjusting signal tunes the acceleration sensing signal and converts the acceleration sensing signal into a decelerated cursor position signal, so as to point at the cursor 61 displayed on the display screen 60, and move the cursor 61 from the position of Point A to the position of Point B on the display screen 60, and the cursor control system can be used for aligning an icon particularly to a very small icon precisely to overcome the difficulty of clicking the small icon.

Of course, the cursor control system of the present invention can be integrated in a mouse, and the cursor control system also comprises a sensing module, a speed tuning module, a signal processing module and a transmission module, wherein the sensing module can be a general optical sensing assembly (such as a trackball) used in a mouse and capable of sensing the movement of the mouse, and the speed tuning module is provided for increasing or decreasing the moving speed of the display screen cursor to improve the convenience for users to control the cursor.

In view of the foregoing method and preferred embodiments of the present invention, the cursor control system of the present invention achieves the effect of controlling a cursor by an intuitive inertial behavior. In other words, the pointing action of a user's hand is basically used for controlling the movement of the cursor on a display device to achieve the effects of facilitate the user's operation, decreasing or increasing the moving speed of the cursor on the display screen effectively. Since the cursor control system is executed independently in the processor, the remote controller or the controlled device, therefore the settings of the moving speed of the cursor of the display screen controlled by the mouse are not affected. The present invention can further meet the user's requirements.

What is claimed is:

1. A cursor control system, for controlling a cursor position, comprising:
a sensing module, having a direction sensing unit and an acceleration sensing unit, and provided for detecting a user's hand movement to generate an angular speed sensing signal and an acceleration sensing signal;
a speed tuning module, having an acceleration mode and a non-acceleration mode, and capable of generating a corresponding speed adjusting signal;
a signal processing module, coupled to the sensing module and the speed tuning module, for receiving the angular speed sensing signal, the acceleration sensing signal and the speed adjusting signal, and further tuning the acceleration sensing signal by the speed adjusting signal, and then converting the tuned angular speed sensing signal and the tuned acceleration sensing signal into a cursor position signal; and
a transmission module, coupled to the signal processing module, for retrieving the cursor position signal of the signal processing module, and capable of outputting the cursor position signal, for controlling a specific cursor position on a display screen.

2. The cursor control system of claim 1, wherein the cursor control system is integrated into a remote control body.

3. The cursor control system of claim 2, wherein the speed tuning module is a pressure sensor, a joystick structure, a knob structure or a press-button structure installed in the remote control body.

4. The cursor control system of claim 1, wherein the direction sensing unit is a gyroscope, a G sensor, a magnetic sensor or an infrared sensor.

5. The cursor control system of claim 1, wherein the transmission module is a cable transmission module.

6. The cursor control system of claim 1, wherein the transmission module is a wireless transmission module.

7. The cursor control system of claim 6, wherein the transmission module is a Bluetooth or infrared module.

8. A cursor control system, for controlling cursor position, comprising:
a sensing module, for detecting a user's hand movement to generate an angular speed sensing signal and an acceleration sensing signal;
a speed tuning module, having an acceleration mode and a non-acceleration mode, and capable of generating a corresponding speed adjusting signal;
a signal processing module, coupled to the sensing module and the speed tuning module, for receiving the angular speed sensing signal, the acceleration sensing signal and the speed adjusting signal, and further tuning the acceleration sensing signal by the speed adjusting signal and converting the tuned angular speed sensing signal and the tuned acceleration sensing signal into a cursor position signal; and
a transmission module, coupled to the signal processing module, for retrieving the cursor position signal of the signal processing module, and capable of outputting the cursor position signal, for controlling a specific cursor position on a display screen.

9. The cursor control system of claim 8, wherein the cursor control system is integrated into a mouse.
